(19) United States
(12) Patent Application Publication
(10) Pub. No.: US 2026/0133539 A1
(43) Pub. Date: May 14, 2026

(54) LIGHTWEIGHT AND ROBUST TIMEPIECE COMPONENT

(71) Applicant: ROLEX SA, Geneva (CH)

(72) Inventors: Florian Calame, Epalinges (CH); Guillaume Deffaugt, Vétraz-Monthoux (FR); Thibaut Riotte, Annecy (FR)

(73) Assignee: ROLEX SA, Geneva (CH)

(21) Appl. No.: 19/373,613

(22) Filed: Oct. 29, 2025

(30) Foreign Application Priority Data
Nov. 12, 2024 (EP) 24212511.0

(51) Int. Cl. G04B 37/22; B33Y 80/00

(52) U.S. Cl. CPC G04B 37/22; B33Y 80/00

(57) ABSTRACT

The method for manufacturing a timepiece component includes: manufacturing a rough skeleton (10a) comprising through-openings (11); manufacturing at least two rough inserts (20b); forming a pre-assembled assembly (30b) by inserting each rough insert (20b) with minimum play into a through-opening (11) of the rough skeleton (10a); molding the pre-assembled assembly (30b) in a mold (201), resulting in the welding of each rough insert (20b) to at least one other rough insert (20b), so as to form an interlocking and inseparable structure with the skeleton (10); finish machining in order to achieve the final dimensions and finishes of the timepiece component.

### CROSS-REFERENCE TO RELATED APPLICATION

This application claims priority of European patent application No. EP24212511.0 filed Nov. 12, 2024, the content of which is hereby incorporated by reference herein in its entirety.

### FIELD OF THE INVENTION

The present invention relates to a method for manufacturing a timepiece component, in particular an exterior timepiece component, such as a case middle, or even more generally any other component. It also relates to a timepiece component per se, such as a case middle, and to a timepiece, in particular a wristwatch, comprising at least one such timepiece component.

### BACKGROUND ART

A timepiece component, and more particularly an exterior timepiece component, must have a number of mechanical properties, sometimes conflicting. These desired properties include:
Lightness, which makes a timepiece comfortable to wear;
A very attractive appearance, free from defects, compatible with the aesthetic requirements of luxury timepieces;
Robustness, in order to withstand the external stresses undergone by a timepiece, so that the timepiece component retains the same appearance in the long term, and more generally retains all of its mechanical properties in the long term.

### SUMMARY OF THE INVENTION

In practice, the existing solutions reflect compromises between these properties. In general, timepiece components are made in solid form from a material that can be both lightweight and hard. However, these existing solutions have limitations, and there is a need to identify new solutions that optimize the properties and/or appearance of timepiece components.

One aim of the present invention is therefore to propose a solution for obtaining a timepiece component, particularly an exterior timepiece component, that is lightweight and robust, and improved in relation to the prior art.

To this end, the invention is based on a method for manufacturing a timepiece component, wherein the method comprises the following steps:
Manufacturing a rough skeleton comprising through-openings;
Manufacturing at least two rough inserts;
Forming a pre-assembled assembly by inserting each rough insert with minimum play into a through-opening of the rough skeleton;
Molding the pre-assembled assembly in a mold, resulting in the welding of each rough insert to at least one other rough insert, so as to form an interlocking and inseparable structure with the skeleton;
Finish machining in order to achieve the final dimensions and finishes of the timepiece component.

The invention is more specifically defined by the claims.

### BRIEF DESCRIPTION OF THE DRAWINGS

These objects, features and advantages of the present invention will be disclosed in detail in the following non-limiting description of a particular embodiment given with reference to the appended figures, in which:

FIG. 1 is a bottom view of a skeleton of a case middle according to one embodiment of the invention.

FIG. 2 is a cross-sectional view along an extended transverse vertical plane AA of the skeleton of the case middle according to the embodiment of the invention.

FIG. 3 is a top view of the skeleton of the case middle according to the embodiment of the invention.

FIG. 4 is an exploded cross-sectional view along an extended transverse vertical plane AA of a pre-assembled assembly according to the embodiment of the invention.

FIG. 5 is a bottom view of the pre-assembled assembly according to the embodiment of the invention.

FIG. 6 is a top view of the pre-assembled assembly according to the embodiment of the invention.

FIG. 7 is a cross-sectional view along an extended transverse vertical plane AA of a pre-assembled assembly according to the embodiment of the invention.

FIG. 8 is a cross-sectional view along an extended transverse vertical plane AA of a device for molding the pre-assembled assembly during a molding step according to the embodiment of the invention.

FIG. 9 shows the change in temperature T in ° C. and load C in kN respectively during the molding step of the manufacturing method according to the embodiment of the invention.

FIG. 10 is a cross-sectional view along an extended transverse vertical plane AA of a rough case middle resulting from the molding step according to the embodiment of the invention.

FIG. 11 is a cross-sectional half view of the case middle according to the embodiment of the invention.

FIG. 12 is a cross-sectional half view of a watch case comprising the case middle according to the embodiment of the invention.

### DETAILED DESCRIPTION OF PARTICULAR EMBODIMENTS

The invention relates to a method for manufacturing a timepiece component, in particular an exterior component, which can particularly be positioned on the periphery of a timepiece or constitute the periphery of a timepiece, such as a case middle. Such a timepiece component thus comprises a first part oriented toward the inside of the timepiece, in particular toward the volume comprising the timepiece movement, which will be referred to as the enclosure, and a second part oriented toward the outside, in particular intended to be visible from the outside of the timepiece. Hereinafter, the adjectives “inside” and “outside” will be used as defined above, even for a timepiece component considered independently of a timepiece, with reference to its intended positioning within a timepiece.

Furthermore, by convention the adjective “horizontal” will be used for any direction positioned in a horizontal plane, the horizontal plane being defined by the plane of the back and/or glass of a timepiece, or the plane tangent to the back and/or to the glass where these elements are not perfectly planar. This horizontal plane thus corresponds to the plane of a timepiece. The adjective “vertical” will be used to denote a direction perpendicular to a horizontal plane. These two adjectives “horizontal” and “vertical” will also be used for a timepiece component considered outside a timepiece, with reference to its predetermined positioning within a timepiece. The “height” of a component will be considered relative to the vertical direction.

Additionally, the adjectives “lower” and “upper” will be used with reference to the vertical direction, the back of a timepiece being in the lower position of the timepiece, the glass being in the upper position of said timepiece. These two adjectives “lower” and “upper” will also be used for a timepiece component considered outside a timepiece, with reference to its predetermined positioning within a timepiece.

It will be noted that the expression “based on a material” will be used to denote that an element mainly comprises said material, in particular comprises at least 50% by weight of said material. In any event, when a particular material is mentioned, it will be possible to use an alternative embodiment with a different material, based on said particular material, which will not be explicitly reiterated. In addition, the simplified expression “component” will sometimes be used to denote a timepiece component, or even improperly a rough timepiece component that is almost finalized. The invention will be particularly described in the context of an exterior timepiece component, but it can be implemented for any other timepiece component. The component can thus take the form of a case middle, as will be described hereinafter, but can also take the form of a link of a strap, or a plate or a bridge of a timepiece movement.

The concept of the invention consists in proposing a timepiece component the structure or rough structure of which is of the “composite” type, comprising the particular association of a rigid, perforated skeleton, forming a reinforcing structure, and having openings filled with a second material.

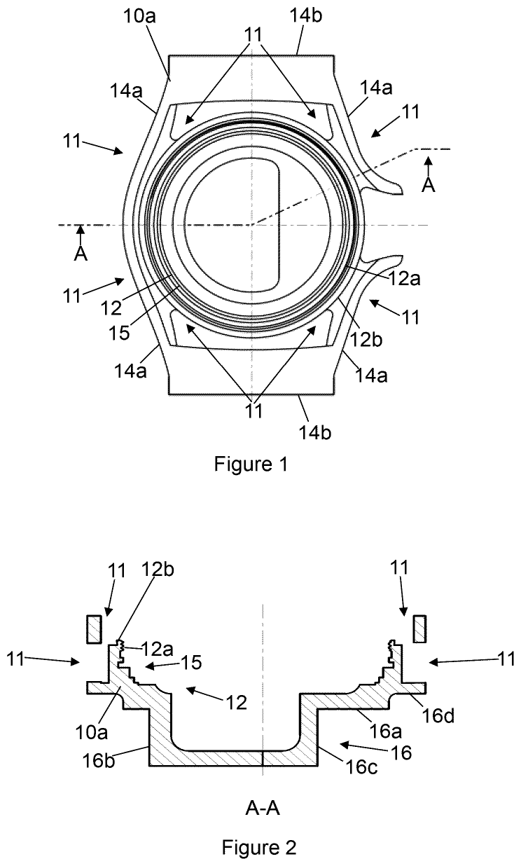

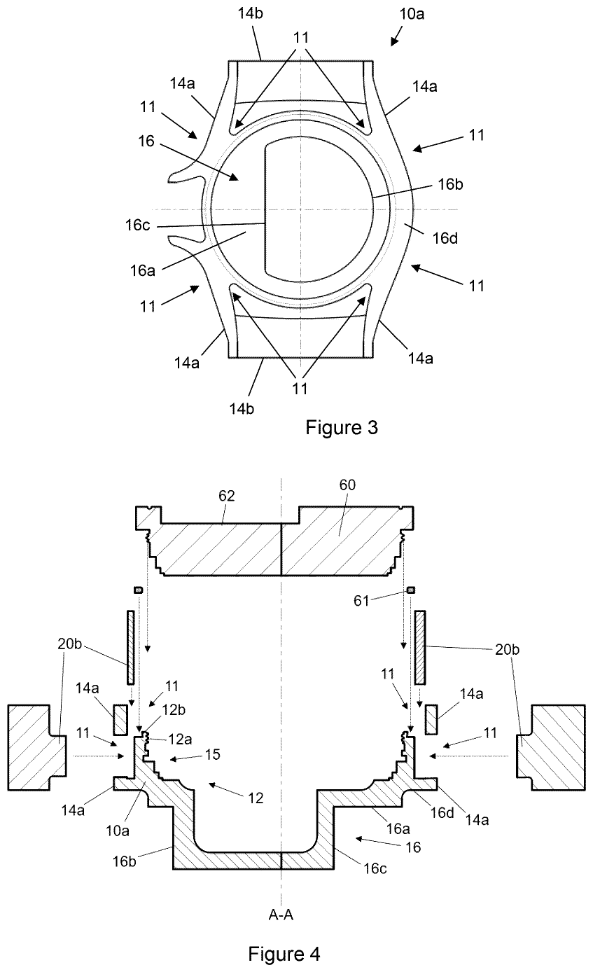

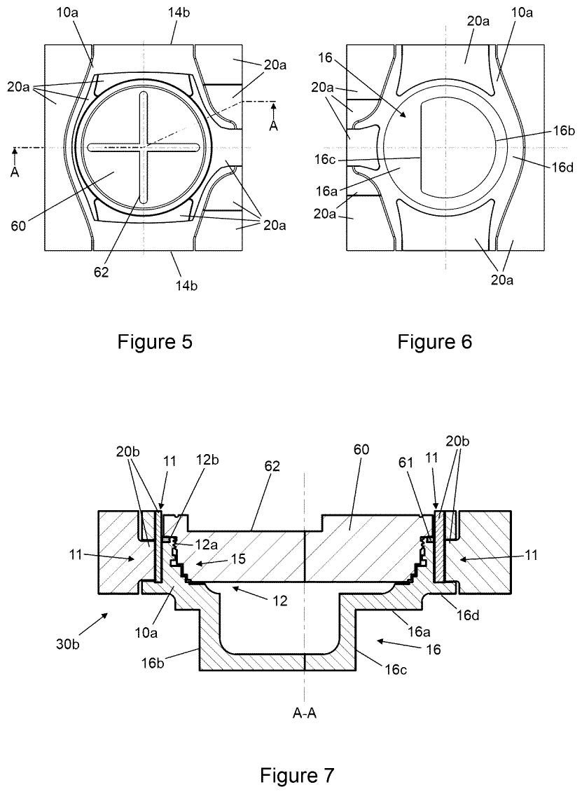

FIGS. 1 to 12 illustrate a method for manufacturing a timepiece component according to one embodiment of the invention, which is a case middle 30, by way of non-limiting example. The same manufacturing method can be used to manufacture a timepiece component other than a case middle, for example more generally any timepiece component having a composite structure, such as a component of a strap, a bezel, a back, or even a component of the movement such as a blank or a plate.

A first step of the manufacturing method according to the embodiment consists in manufacturing a rough skeleton 10a, comprising through-openings 11. Such a rough skeleton is perforated and is shown in FIGS. 1 to 3. In this first step, the rough skeleton 10a can be machined by conventional means, in particular by removal of material. As a variant, it can be produced by 3D printing, molding or sintering, and then optionally reworked using machining means, which makes it possible in particular to achieve greater manufacturing precision and to achieve certain geometries that would be impossible or very difficult to obtain by conventional machining methods by removal of material. This skeleton is rough in the sense that it does not yet have its final shape, but comprises certain portions that will be modified later, in order to achieve the structure of the finalized skeleton 10.

This skeleton can advantageously have a continuous shape arranged around a vertical central axis, suitable for several timepiece components such as the case middle that is manufactured in this embodiment, defining a central volume or enclosure 12, intended to form the inner volume of the case middle, which is intended in particular to receive the timepiece movement of the timepiece. Advantageously, the skeleton forms an integrally formed one-piece assembly.

This rough skeleton 10a can comprise, be based on, or consist of a metal or a metal alloy, in particular comprising steel, gold, platinum, silver, bronze, titanium, such as grade 5 titanium or titanium aluminide, aluminum, or magnesium. As a variant, it can comprise, be based on, or consist of an engineering ceramic, in particular based on alumina or zirconia. As another variant, it can comprise, or be based on, or consist of organic or inorganic compounds.

It will be noted that the properties of the material selected to form the skeleton, such as the melting temperature and/or the hardness and/or the ductility and/or the yield strength and/or the tensile strength, are compatible with the method described below. For example, these properties can be superior to those of the inserts described below, in order to maintain the integrity of the skeleton during a molding step described hereinafter.

As mentioned above, the skeleton comprises through-openings. These openings are capable of receiving inserts, as specified hereinafter. Preferably, these openings emerge on the outside of the rough skeleton. These openings are advantageously through-openings or open, that is, their two ends emerge either on the outside of the skeleton or into another opening of the skeleton. In other words, the openings are through-openings because they are not blind. Also advantageously, these openings, or pores or gaps, communicate with each other. For example, the rough skeleton can have a regular or irregular perforated network structure, in particular of the lattice, TPMS, alveolar, cellular or trabecular type. The lattice network can in particular comprise partitions that intersect randomly or at clearly defined intervals. This structure can comprise the repetition of one or more juxtaposed elementary elements, in particular in contact with each other to form a continuous, perforated structure. Advantageously, the through-openings do not emerge on the inside of the case middle, in order to guarantee a perfect seal on the surface defining the enclosure 12 intended to receive the timepiece movement.

In this embodiment, in order to maintain the integrity of the rough skeleton 10a throughout the manufacturing method, in particular during the compression molding step described below, the rough skeleton 10a comprises reinforcing portions 14a, 14b that make it possible to stiffen its structure. The reinforcing portions can take the form of additional thicknesses, pillars, lattices or any other geometry that makes it possible to stiffen the structure. They can be oriented so as to absorb the forces of the molding described hereinafter. They can be permanent or removed during a step subsequent to the molding step of the method, for example during a finishing or reworking step. By way of example, the rough skeleton 10a shown according to this exemplary embodiment comprises reinforcements that take the form in particular of pillars 14b arranged between the horns of the case middle 30, and additional thicknesses 14a formed in particular on the case middle flanks.

So that precise references are available for the subsequent steps, the rough skeleton 10a is advantageously reworked by conventional machining. Thus, rework portions 16 are formed by machining with great precision on the rough skeleton. They are intended for a particular function for the molding step and the subsequent steps of the manufacturing method, described hereinafter, allowing in particular precise orientation and positioning of the rough skeleton 10a during these steps. This results in great dimensional precision, free from defects, in particular during the molding of the inserts. In this embodiment, the rework portions 16 take the form of a support 16a, a cylinder 16b, a flat segment 16c, and a second support 16d, positioned on the upper side of the case middle, that is to say the side intended to receive a glass, opposite the back of the future timepiece.

Advantageously, the rework portions 16 also perform a function of stiffening the rough skeleton 10a. Preferably, they can close one of the sides of the enclosure 12, which thus becomes a blind enclosure. These rework portions are intended to be removed during a finishing step described hereinafter.

Furthermore, the skeleton advantageously comprises finish portions 15, likewise advantageously machined on the rough skeleton 10a to have precise dimensions, or even finished or final dimensions, the function of which is to form optimum references for the steps subsequent to molding, in particular during the finishing step described hereinafter. Advantageously, certain finish portions 15 also form functional portions of the inner surface of the rough skeleton, on the contour of the enclosure 12, for example surfaces intended for receiving or encasing the timepiece movement. Such an approach is advantageous since these functional portions require great precision in their structure.

The manufacturing method according to the embodiment then comprises a second step consisting in manufacturing several rough inserts 20b, intended to be assembled with the rough skeleton 10a mentioned above. There can be any number of rough inserts, such as at least two. These inserts are rough in the sense that they are in a temporary form, which will be modified by the manufacturing method in order to obtain the timepiece component provided with inserts 20.

Each rough insert 20b is intended to be incorporated into the rough skeleton 10a by positioning it in one of the through-openings 11 of the rough skeleton 10a. To this end, each rough insert 20b is manufactured with great precision so that it complements the corresponding opening 11 of the rough skeleton 10a into which it is intended to be placed. The rough inserts 20b are thus advantageously not injection molded but take the form of machined or preformed elements. Such machining of the rough inserts 20b combines, for example, means for removing material and water jet cutting or laser cutting.

Furthermore, each rough insert 20b can be molded and/or machined from the same block of material, which makes it possible to ensure a structurally and/or aesthetically coherent assembly, once the inserts 20 have been assembled or molded within the skeleton 10. With this approach, it is possible to use materials that are heterogeneous in terms of composition, structure and/or aesthetics, while maintaining unity in terms of the heterogeneity of the inserts 20 associated with the skeleton 10. The block of material used could thus have variations in structure and/or color, for example. As a variant, all of the rough inserts 20b arranged on the same side of the case middle are machined from the same block of material. Several separate blocks of material can be used.

According to one embodiment, the rough inserts comprise, or are based on, or consist of, a composite material, such as a polymer such as a thermoplastic, in particular a PEKK, a PEEK or a PPS. Optionally, the rough inserts comprise a resin matrix incorporating short or long fibers, in particular glass, carbon, inorganic or organic fibers, or engineering ceramic powders, in particular based on alumina or zirconia, or pigments of luminescent material. These fibers can be oriented so as to promote mechanical strength in preferred directions and/or to maintain the coherence of any units of the composite material once the inserts 20 have been assembled with the skeleton 10. For example, the fibers can be oriented in a longitudinal direction relative to the flanks of the case middle. In addition, these fibers can in particular represent a volume ratio of approximately 60%,

In addition, depending on the embodiment, the rough inserts 20b are provided with an additional thickness or excess material on their outer part. The excess material can be used for the compression molding step, described hereinafter. Advantageously, the excess material can be shared or pooled between several inserts, so that there is just one element to fill multiple through-openings 11, for example. In other words, the rough inserts 20b can be independent of one another or connected to each other by excess material.

In the embodiment in which excess material is shared or pooled between several inserts, this excess also contributes to maintaining structural and/or aesthetic coherence among the various inserts assembled on the rough skeleton 10a, which is particularly advantageous for rough inserts 20b manufactured from composite material, for example.

In the proposed solution, some or all of the rough inserts 20b located on each flank of the case middle are respectively supported by a single element, by virtue of its excess material.

The manufacturing method then implements a third step in which the rough inserts 20b are assembled with the rough skeleton 10a to form a pre-assembled assembly 30b. FIGS. 4 to 7 show such a pre-assembled assembly 30b, which is therefore a pre-assembled case middle 30b according to the embodiment, forming a temporary assembly prepared for the subsequent molding step described below. Due to the precise manufacturing described above, each rough insert 20b is molded and/or machined with great precision so that it can be assembled and fitted with minimum play in its respective through-opening 11.

In addition, according to this embodiment, a protective element 60 is assembled with the rough skeleton 10a, so as to plug the open side of the enclosure 12, that is the lower side, opposite the side closed by a rework portion 16. Such a protective element 60 makes it possible to obtain a completely closed and sealed inner enclosure 12 and to maintain the integrity of the portions of the inner surface of the pre-assembled assembly, in particular the finish portions 15.

Naturally, the rough skeleton 10a and the pre-assembled assembly 30b can take several different forms without departing from the scope of the invention. In particular, the enclosure 12, delimited by this pre-assembled assembly, can have several through-openings through the pre-assembled assembly 30b, for example with a view to incorporating control buttons such as pushbuttons or crowns on the final timepiece. Thus, more generally, when the enclosure 12 comprises through-openings in several places, several protective elements 60 can be assembled with the pre-assembled assembly 30b, so as to plug and seal the enclosure 12 by closing all of these through-openings.

In this operation, a protective element 60 can be removably assembled with the rough skeleton 10a. In addition, in order to guarantee optimum sealing, a seal 61, in particular made form a copper-containing material, can be placed at the interface between a protective element 60 and the rough skeleton 10a. Once assembled, the protective element 60 can advantageously help to further stiffen the rough skeleton 10a in order to withstand the pressures generated during the molding step.

According to one embodiment, a protective element 60 can take the form of a plug made from a copper-containing material, more particularly brass. It can be assembled by any means. For example, it can be screwed into an internal thread 12a of the rough skeleton 10a, for example an internal thread provided for fastening a back 40 of the future timepiece. A recess 12b can therefore be provided level with such an internal thread 12a, in order to accommodate a seal 61. A plug can comprise a cavity 62 so that it can be screwed into and unscrewed from the rough skeleton 10a easily with a suitable tool.

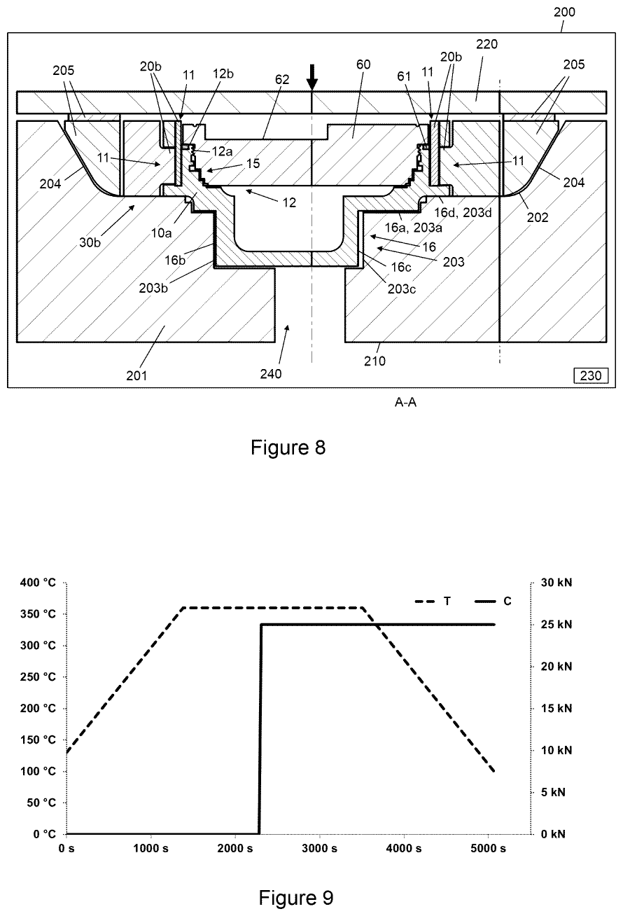

The manufacturing method then comprises a fourth step of molding the pre-assembled assembly 30b in a mold, in order to obtain a molded pre-assembled assembly, that is, a molded case middle in this instance. Such a step results in the welding of the at least two rough inserts 20b to each other, and the final positioning of the inserts so as to form an interlocking and inseparable structure with the skeleton. This step therefore makes it possible to rigidly connect the rough inserts 20b to the rough skeleton 10a. FIGS. 8 and 9 illustrate the implementation of this fourth step. It will be noted that “final positioning” is given to mean in particular a positioning that particularly aims to eliminate the play between the inserts and the through-openings 11 of the skeleton. Finally, the aforementioned “welding” between at least two rough inserts 20b ensures the continuity of the material to be assembled; it is obtained in particular by heating and melting of the material at least locally. In other words, this assembly method makes it possible to rigidly connect or fuse the components to each other.

In this step, the pre-assembled case middle 30b is positioned in a mold 201 of a compression molding device 200, between a support plate 210 and a pressure plate 220. To this end, the mold 201 has a cavity 202 intended to receive the pre-assembled case middle 30b. This cavity can be arranged in the support plate 210 and/or the pressure plate 220 of the compression molding device 200.

Advantageously, the mold 201 comprises references 203 complementary to the rework portions 16 of the rough skeleton 10a, so as to allow the precise and correctly oriented positioning of the rough skeleton 10a and therefore of the pre-assembled assembly 30b, that is, the pre-assembled case middle. More particularly, the mold 201 comprises references 203a, 203b, 203c, 203d that are respectively complementary to the rework portions 16a, 16b, 16c, 16d of the rough skeleton 10a.

The mold 201 is also advantageously designed so as to guide or promote the flow of the rough inserts 20b in the direction in which they are inserted into their through-opening 11 during the molding step. To this end, the mold 201 can comprise inclined surfaces 204 that make it possible to redirect the orientation of the force supplied by the pressure plate 220 toward the direction of insertion of the rough inserts 20b.

Also advantageously, the mold 201 comprises draft angles that make it easy to demold the case middle. In addition, the mold 201 can comprise ejectors or at least openings 240 intended to receive them, so as to facilitate the ejection of the case middle from the mold 201. Finally, the mold 201 can comprise flash grooves or vents. The flash grooves allow excess material (flash) to be ejected and/or allow trapped air or gases to be vented. The aforementioned openings 240 can also be used for venting air or gases.

Additionally, filling elements 205 can be assembled in the mold 201 so as to fill the gaps between the wall of the cavity 202 of the mold and the pre-assembled assembly 30b. Such filling elements 205 can also help to guide the flow of the rough inserts 20b in the direction of their through-opening 11. They can also be used as a reserve of material for the compression molding step. Preferably, these filling elements 205 are made from the same material as the rough inserts 20b. Also preferably, the filling elements 205 are machined from the same block of material as the rough inserts 20b. Alternatively, the filling elements 205 could be made from a metallic material, and designed so that they move against the rough inserts 20b when the mold is pressurized.

As a further alternative, the gaps between the wall of the cavity 202 of the mold 201 and the pre-assembled assembly 30b can also be filled with material supplied by an injection molding device which, at the same time, makes it possible to pressurize the mold so as to rigidly connect the rough inserts 20b to the rough skeleton 10a. It is thus the pressure supplied by the injection of the material that compresses the rough inserts against the rough skeleton, and not the movement of the pressure plate 220. Of course, the mold must be adapted so as to allow such a use. Preferably, the injected material is of the same type as the rough inserts.

According to the embodiment shown, the pre-assembled assembly 30b is arranged in the mold 201 with the upper side oriented toward a bottom 203d of the cavity 202. The mold 201 is designed so that a rework portion 16d of the rough skeleton 10a is pressed against this bottom 203d of the mold cavity by the pressure exerted during molding, so as to create a sealed interface that prevents the rough inserts 20b from flowing onto the various rework portions 16 and/or finish portions 15. In general, the interaction between the mold 201 and the pre-assembled assembly 30b, and more specifically the rough skeleton 10a, is designed so as to prevent the flowing of the inserts 20b from contaminating the rework portions 16 during the molding step.

The inclined surfaces 204 forming the upper wall of the cavity 202 of the mold also comprise a draft angle of 30° relative to the direction of insertion of the pre-assembled assembly 30b and to the direction of movement of the pressure plate 220. The draft angles of these inclined surfaces 204 are also used to reorient the force of the pressure plate 220 in the direction of insertion of the rough inserts 20b into the through-openings 11, as explained above. In other words, the force of the pressure plate 220 is reoriented in a direction substantially perpendicular to the direction of movement of the pressure plate 220.

Filling elements 205 are positioned on the periphery of the pre-assembled case middle, in a plane perpendicular to the direction of movement of the pressure plate 220.

Preferably, the compression molding device 200 is provided with at least one heating and cooling system 230. The heat input makes it possible to melt the rough inserts 20b to allow them to flow during the molding and compression step. Preferably, the system is controlled so as to allow the temperature to be regulated during pressurization, but also during the heating and cooling of the mold 201. This makes it possible in particular to better control the flow and the rigid connection of the inserts, as well as the filling of the through-openings of the rough skeleton 10a.

FIG. 9 illustrates more precisely the possible sub-steps of the fourth step of molding the pre-assembled assembly, in the case of inserts made from a PEKK thermoplastic reinforced with carbon fibers, and a rough skeleton 10a made from grade 5 titanium or titanium aluminide. These sub-steps can be as follows:
a. Increasing the temperature of the mold 201 until it reaches a temperature setpoint T, for example 360° C., according to a pre-defined gradient, for example 10° C./min.
b. Maintaining the temperature of the mold 201 at the temperature setpoint T for a pre-determined period, for example 900 seconds, so as to ensure that the temperature of the mold and the pre-assembled case middle 30b is uniform.
c. Pressurizing the mold 201 with a pre-defined load C, for example 25 KN, preferably maintained until the end of the cooling sub-step below.
d. Cooling the mold 201 until it reaches a temperature setpoint T, for example 130° C., according to a pre-defined gradient, for example 10° C./min. Then, this fourth step comprises the following sub-steps:
e. Demolding the molded case middle 30a.
f. Cooling the molded case middle 30a to ambient temperature.

According to the exemplary embodiment, the material of the inserts is a PEKK thermoplastic that advantageously provides a high melting temperature, greater than 270° C., or even greater than 300° C., or even up to 360° C. Optimum flow of the material of the inserts is thus obtained during the method; the temperature setpoint for the molding step is preferably equal to or even 10° C. or 20° C. or even 30° C. less than the melting temperature of said material. Advantageously, the material is filled with carbon fibers, referred to as long fibers and oriented in a longitudinal direction relative to the flanks of the case middle.

Advantageously, each through-opening 11 of the rough skeleton 10a is intended to receive a rough insert 20b. Due to the manufacturing according to the first steps described above, these rough inserts 20b are inserted into the openings with minimum play. The molding step described above allows the material of the inserts to flow. Since these openings are through-openings and communicate with each other, during this flow, the material of at least two inserts comes into contact, which makes it possible to weld these rough inserts 20b to each other within the rough skeleton 10a. In other words, two through-openings 11, respectively comprising at least two rough inserts 20b, are non-blind openings, the respective ends of which communicate with each other, making it possible to rigidly connect the two respective rough inserts 20b.

More generally, compression molding makes it possible to melt, or at least to render malleable, at least superficially or locally, the rough inserts 20b, so as to rigidly connect or weld them to each other on the rough skeleton 10a. In this step, the pre-assembled assembly is heated and then pressurized. As they flow, the inserts will also fill the gaps and adhere to the rough skeleton 10a.

It will be noted that the rigid connection or welding can take place by surface or local melting, at least at the contact interface between the at least two rough inserts 20b. The rigid connection or welding can also take place by total or substantially total melting thereof. “Rigid connection” is given to mean a permanent fastening, a definitive, inseparable and irreversible assembly, between at least two components. The rigid connection is produced without the need for an additional component and without the addition of any material such as glue or brazing material.

This rigid connection or welding of the rough inserts 20b fused to each other within the through-openings 11 results in a robust, interlocked, non-detachable or inseparable assembly, which is particularly resistant to the environmental stresses and to the various accidental impacts that the future timepiece might undergo during wear.

Furthermore, the various through-openings 11 of the rough skeleton 10a therefore advantageously emerge toward the outside of the rough skeleton 10a, and into each other. In addition, again advantageously, in order to guarantee a completely sealed casing, the through-openings 11 of the rough skeleton 10a do not emerge into the enclosure 12 of the rough skeleton 10a. The material of the inserts thus cannot flow into the enclosure 12 through the perforated structure of the rough skeleton 10a.

It will be noted that in this embodiment, one or more protective elements 60 are advantageously assembled with the rough skeleton 10a, as described above, so as to seal the enclosure 12 of the pre-assembled assembly, which makes it possible to prevent the flowing of the rough inserts 20b from contaminating the finish portions 15 and the rework portions 16.

According to one variant embodiment, the mold 201 can be adapted so as to allow the simultaneous molding of several timepiece components.

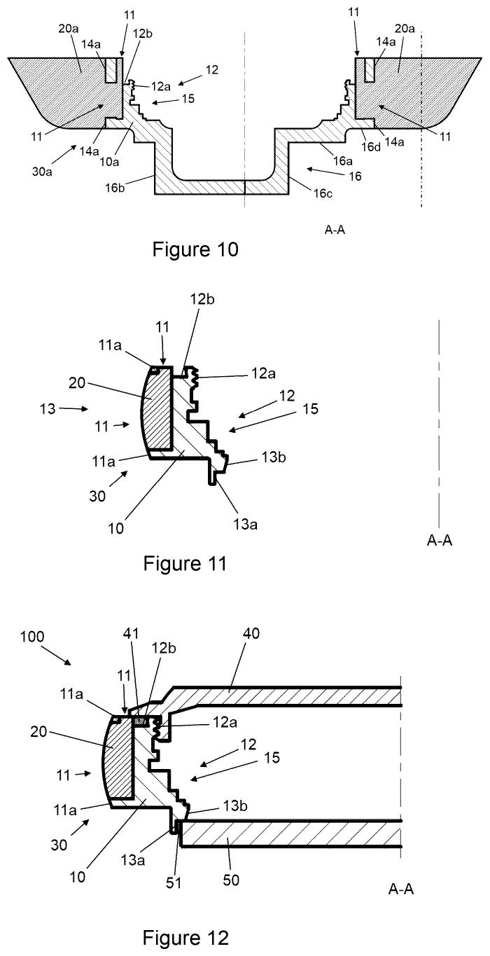

The manufacturing method then comprises a fifth step of finishing, after demolding the pre-assembled assembly, forming a molded assembly 30a, comprising a rough skeleton 10a and molded inserts 20a, in order to achieve the final dimensions and finishes of the timepiece component, that is the case middle in this exemplary embodiment. In this step, the rework portions 16 are modified or removed, while the finish portions 15 remain unchanged. This step is illustrated in FIGS. 10 and 11.

In this step, the shape of the case middle can be reworked by conventional machining means, such as removal of material. By using predefined rework portions 16, the excess thicknesses and excess material, present in particular on the flanks and the lower part of the case middle, are removed with optimum precision. In this step, the finish portions 15 are used for precise machining of the rework portions 16. According to the embodiment, the finish portions 15 are used to remove rework portions 16 by machining a stack 13a and a flange 13b, in particular intended for fastening a glass 50 by means of a seal 51, as shown in FIG. 12, which depicts the finalized timepiece component.

Since the rework portions 16 and the finish portions 15 are anticipated and protected during the molding step, their integrity is maintained, which guarantees the reworking of the molded assembly 30a with optimum precision, not prejudiced by potential geometric inaccuracies resulting from the molding step. This precision is advantageous in particular to ensure that the thicknesses of the protective portions 11a, which will be described in detail hereinafter, are uniform around the inserts 20 of the finalized composite case middle 30.

More specifically, the rework portions 16 make it possible in particular to rework the molded assembly 30a by removing the excess material originating from the molded inserts 20a and certain reinforcing portions 14a, 14b. Advantageously, the rework portions 16 allow optimum positioning and orientation of the molded case middle 30a during this finishing step.

The finish portions 15 then make it possible to remove the rework portions 16, while machining functional portions 13a, 13b of the case middle, these functional portions making it possible, inter alia, to assemble a glass 50 on the case middle according to this exemplary embodiment. The enclosure 12 then also emerges on the upper part, in addition to the lower part, after the removal of the protective element or elements 60.

The rework carried out in the first step makes it possible to machine part or all of the enclosure 12 of the case middle intended to encase a movement. In this embodiment, it comprises machining from the lower face intended to comprise a back 40. An internal thread 12a and a recess 12b for receiving a seal have in particular been machined to allow the sealable fastening of a screwed back 40.

The invention also relates to a timepiece component per se resulting from the manufacturing method described above, and particularly to a timepiece case middle. FIG. 12 thus illustrates a case middle 30 according to one embodiment of the invention.

In general, the timepiece case middle according to the embodiment comprises a skeleton 10 forming a reinforcing structure of the case middle, said skeleton comprising through-openings and defining a central enclosure 12, and said skeleton 10 forming at least one device 12a, 13a, 13b for fastening a back 40 and/or a glass 50 and/or a bezel and/or a control member and/or a strap. The case middle additionally comprises at least two inserts 20 welded to each other to form at least one continuous assembly through at least two through-openings of the skeleton, in order to form at least one interlocked structure comprising said at least two inserts 20 and said skeleton 10, at least one of said two inserts 20 forming at least part of the outer surface of the case middle 30.

The case middle has a conventional generally annular shape, which defines a central volume or enclosure 12 intended to receive a timepiece movement. The skeleton 10 particularly defines this enclosure 12, and is designed so as to allow precise encasing or casing of a timepiece movement. In other words, the enclosure 12 of the skeleton 10 is manufactured so as to allow precise fastening and adjustment of the movement within it. The skeleton 10 can comprise a surface for receiving such a movement, at the interface with the enclosure 12.

The enclosure 12 is also designed to provide a casing that allows optimum sealing. To this end, the skeleton 10 defines recesses 12b, 13a for seals 41, 51, at the interfaces between the components of a watch case 100, such as a glass, a back, or a timepiece case, and the skeleton 10. Each recess 12b, 13a can be machined on the skeleton 10 and/or on an adjacent component of the case, associated with the skeleton.

According to the exemplary embodiment in FIG. 12, a back 40 is screwed into an internal thread 12a of the skeleton 10, and a seal 41 is placed in a recess 12b positioned at the interface between the back 40 and the skeleton 10. In addition, a glass 50 is driven onto a stack 13a of the skeleton 10, and a seal 51 is likewise placed at the interface between the glass 50 and the skeleton 10. This embodiment makes it possible to form a sealed enclosure 12, intended to receive a movement. Preferably, the seals are received in recesses of the skeleton 10 in order to benefit from high-quality surface finishes and thus guarantee optimum sealing.

The skeleton 10 of the case middle 30 forms part of the outer surface of the case middle, in particular located level with edges or chamfers positioned on the flanks of the case middle, horns, and a flange. All or some of the outer surfaces of the case middle, in particular the visible surfaces, can be finished with high quality finishes, in line with the finishes selected for the rest of the case middle, such as in particular polishing or satin finishing.

The skeleton advantageously comprises at least one protective edge positioned on a visible outer edge of an insert. Protective portions 11a are advantageously arranged on said outer surfaces and are used to protect the inserts 20 from the external environment, in particular from impacts or friction, which could chip or damage the outer surface or edges of the inserts 20, which are made from a less hard material than the skeleton 10. These protective portions 11a form reinforced zones in places that are heavily loaded or highly exposed. It is therefore advantageous to design a skeleton made from a material having, in particular, greater yield strength, hardness, or ductility than the inserts. The protective portions 11a can take the form of surfaces, edges or chamfers completely or partially surrounding the visible edges of the inserts 20.

Advantageously, the skeleton comprises through-openings 11 that are all filled with inserts, each insert being welded or fused with at least one other insert, and optionally with the skeleton, to form at least one continuous assembly of the material of the inserts within the skeleton, and to form at least one inseparable interlocked structure comprising said inserts 20 and said skeleton 10.

The invention also relates to a timepiece that comprises a case middle 30 as described above. The timepiece can comprise a glass 50 fastened to the skeleton 10 of the case middle 30 and/or a back 40 fastened to the skeleton 10 of the case middle 30 and/or a bezel fastened to the skeleton of the case middle and/or a control member, such as a pushbutton or a crown, fastened to the skeleton of the case middle, and/or a strap fastened to the skeleton of the case middle.

Finally, the solution proposed by the invention has the following advantages:
It makes it possible to significantly reduce the mass of a case middle, and therefore of a watch case, while making it possible to achieve very high mechanical strength. The most fragile parts formed by the inserts can be protected by the skeleton;
With respect to a case middle, it makes it possible to encase a timepiece movement with a very precise fit, and offers optimum protection of the movement against elements of the external environment such as dust, moisture, immersion in water and impacts;
The choice of materials makes it possible to meet mechanical requirements, while offering multiple aesthetic possibilities;
The skeleton can have a complex perforated structure, and the method guarantees the presence of the inserts within a complex and deep geometry;
The timepiece component, in particular the case middle, can reach a very precise final shape.

In summary, the invention therefore makes it possible to combine two major objectives for a component, in particular an exterior timepiece component, that were not previously achieved. It makes it possible to obtain both a lightweight component and a mechanically robust component, while being aesthetically attractive.

Naturally, the invention is not limited to the specific geometry of the skeleton as described above. Advanced design methods such as numerical simulation and topology optimization (assisted or not by an artificial intelligence model and/or by a machine learning model) can be advantageously used for the definition and dimensioning of the skeleton 10. These methods make it possible to distribute the material of the skeleton only where it is necessary to perform the required functions, in particular to withstand mechanical stresses, which makes it possible to considerably reduce the total mass of the component without compromising its mechanical strength.

In addition, this concept of a two-part composite architecture could only be partially implemented in the volume of the timepiece component, that is, it is not necessarily in the entire volume.

The invention is particularly suitable for any component, in particular any timepiece component, in particular any exterior component, as stated above.

1. A method for manufacturing a timepiece component, wherein the method comprises:
manufacturing rough skeleton comprising through-openings;
manufacturing at least two rough inserts;
forming pre-assembled assembly by inserting each rough insert with minimum play into a through-opening of the rough skeleton;
molding the pre-assembled assembly in a mold, resulting in the welding of each rough insert to at least one other rough insert, so as to form an interlocking and inseparable structure with the skeleton; and
finish machining to achieve the final dimensions and finishes of the timepiece component.

2. The method as claimed in claim 1, wherein
the manufacturing of the rough skeleton forms rework portions and finish portions, and
the finish machining leaves the finish portions unchanged and modifies or removes the rework portions.

3. The method as claimed in claim 2, wherein the mold comprises portions forming reference elements complementary to the rework portions of the rough skeleton, so as to position and orient the rough skeleton of the pre-assembled assembly at the bottom of the mold, creating sealed interfaces that prevent the material of the rough inserts from covering the rework portions of the rough skeleton.

4. The method as claimed in claim 1, wherein the method comprises assembling at least one protective element on the rough skeleton of the pre-assembled assembly before implementation of the molding of the pre-assembled assembly, so as to protect all or part of the pre-assembled assembly, and/or so as to stiffen the rough skeleton and maintain an integrity of the rough skeleton during the molding.

5. The method as claimed in claim 4, wherein
the rough skeleton defines an inner enclosure, and
protective element is assembled with the rough skeleton so as to sealably close an open face of the inner enclosure.

6. The method as claimed in claim 1, wherein the molding of the pre-assembled assembly comprises:
heating to cause the rough inserts to flow, and
compressing to fill the through-openings )of the skeleton with material of the rough inserts, and to weld the rough inserts to each other.

7. The method as claimed in claim 1, wherein the manufacturing of the rough skeleton is implemented by machining or three-dimensional printing or molding or sintering.

8. The method as claimed in claim 1, wherein the manufacturing of the rough skeleton forms the rough skeleton comprising through-openings emerging on an outside of the rough skeleton and communicating with each other.

9. The method as claimed in claim 1, wherein the method manufactures the skeleton comprising recesses adapted for positioning seals at the interfaces with other components such as a glass, a back, or a protective element.

10. The method as claimed in claim 1, wherein the manufacturing of the rough inserts comprises machining or molding from the same block in a material having a lower melting point than the material of the rough skeleton.

11. The method as claimed in claim 1, wherein the manufacturing of the rough inserts comprises forming an additional thickness or excess material on an outer part of the rough inserts, the rough inserts being independent of each other or connected to each other by the excess material.

12. The method as claimed in claim 1, wherein the timepiece component is a case middle, a component of a strap, a bezel, a back, a dial, or a component of a timepiece movement.

13. The method as claimed in claim 1, wherein
the timepiece component is a case middle,
the rough skeleton defines an inner enclosure adapted to receive a timepiece movement, and
the rough skeleton comprises at least one portion forming at least one device for fastening a back and/or a glass and/or a bezel and/or a control member and/or a strap.

14. The method as claimed in claim 13, wherein
the rework portions comprise a support surface, a cylinder, and a flat segment, positioned on an upper side, outside the inner enclosure of the case middle, and the method comprises a finishing comprising removal of the rework portions by machining a stack and a flange, forming a device for fastening a glass.

15. The method as claimed in claim 4, wherein the assembling of the at least one protective element on the rough skeleton of the pre-assembled assembly before implementation of the molding of the pre-assembled assembly, is so as to protect rework portions of the rough skeleton and/or openings of the skeleton and/or finish portions.

16. The method as claimed in claim 15, wherein the assembling of the at least one protective element on the rough skeleton of the pre-assembled assembly before implementation of the molding of the pre-assembled assembly, is so as to protect the openings in the skeleton designed level with through-holes for controls such as pushbuttons or a winding crown.

17. The method as claimed in claim 6, wherein the heating and the compressing bond the rough inserts to the skeleton.

18. The method as claimed in claim 17, wherein the heating is a controlled heating.

19. The method as claimed in claim 7, wherein the manufacturing of the rough skeleton includes reworking using machining to achieve a final precision of at least the finish portions of the rough skeleton.

20. The method as claimed in claim 8, wherein the through-openings do not emerge on the inside into an enclosure of the rough skeleton.
